(19) United States
(12) Patent Application Publication
(10) Pub. No.: US 2022/0161221 A1
(43) Pub. Date: May 26, 2022

(54) INTERNALLY COOLED IMPEDANCE TUNER FOR MICROWAVE PYROLYSIS SYSTEMS

(71) Applicant: Pyrowave Inc., Oakville (CA)

(72) Inventors: Jocelyn Doucet, Montréal (CA); Jean-Philippe Laviolette, Montréal (CA)

(21) Appl. No.: 17/601,245

(22) PCT Filed: Apr. 3, 2020
(86) PCT No.: PCT/IB2020/053227

§ 371 Date: Oct. 4, 2021

Related U.S. Application Data
(60) Provisional application No. 62/829,947, filed on Apr. 5, 2019.
(60) Provisional application No. 62/855,077, filed on May 31, 2019.

(51) Int. Cl. B01J 19/12; B01J 6/00

(52) U.S. Cl. CPC B01J 19/126; B01J 6/008

(57) ABSTRACT

An internally cooled microwave stub tuner assembly with stubs having hollow ducts for receiving circulating cooling fluid while in operation. The microwave stub tuner assembly for a pyrolysis reactor includes at least one elongated hollow body plunger projecting into a waveguide cavity. Each of the hollow body portion of the plungers has at least one internal cooling duct for receiving a circulating cooling fluid and is adapted to be cooled by the circulating cooling fluid as the circulating cooling fluid enters the plunger, courses through each the internal cooling ducts and exits the plunger. Each plunger has a position adjuster for adjusting the position of the plunger within the waveguide cavity.

### TECHNICAL FIELD

The present invention relates to the field of pyrolysis, and more particularly to a coupler for microwave pyrolysis systems.

### BACKGROUND

Pyrolysis of products such as biomass and plastics is usually performed in a reactor by adding heat under anaerobic condition, i.e. in an atmosphere deprived of oxygen. There are usually three main reaction products: oil, gas and carbon black. In most cases, the pyrolysis process is tuned to maximize oil yield since it usually has the most value as a source of chemicals or fuel.

The conventional heating source for pyrolysis usually comprises combustion of a fuel-gas to make a flame and hot combustion gases or resistive electrical heating elements. In such conventional pyrolysis systems, the external surface of the reactor is heated so that heat can be transferred to the product to be pyrolyzed via heat conduction through the reactor walls including the side walls or bottom.

However, at least some of the conventional pyrolysis systems have at least some of the following drawbacks.

At least some of the conventional pyrolysis systems provide low oil yield because the heating rate of the product to be pyrolyzed is relatively low, which results in low oil yield. This is due to the fact that the heating rate of the product is determined by the temperature of the vessel wall. i.e. the higher the vessel wall temperature, the higher the product heating rate. The maximum vessel wall heating rate and therefore the final temperature of the product are usually determined by thermal inertia of the vessel, the heat source power, the heat losses, the selection of vessel wall alloy, the surface area and the heat transfer coefficient. All these constraints limit the heating rate of the feedstock. However, selection of alloys that can sustain high temperatures (such as Inconel™ or titanium) increase the capital cost of the system.

Furthermore, low final product temperatures (i.e. low reaction temperatures) result in low reaction rates and also affect the reaction kinetics. Also, since the reactor walls are heated to a temperature higher than the product to be pyrolyzed, the product experiences an increase in temperature as it leaves the reactor walls, which may cause degradation of the product.

In order to overcome at least some the above-described deficiencies of conventional pyrolysis systems, microwave pyrolysis systems have been developed. Such microwave pyrolysis systems use microwaves to heat a product to be pyrolyzed placed into a reactor.

Microwaves are electromagnetic waves: a traveling electrical field perpendicular to a magnetic field. Microwaves used for heating applications typically have frequencies of 2.45 GHz (low power below 15 kW) and 915 MHz (high power as high as 100 kW)—these frequencies are fixed and determined by international regulations.

Some of the main advantages of microwave pyrolysis systems over conventional pyrolysis systems include high heating rates which lead to high product yields, high reaction site temperatures which leads to high reaction rates and improves the kinetics, rapid temperature adjustments and also low environment temperatures which allows avoiding the degradation of the product of the pyrolysis reaction.

However, some issues with microwave pyrolysis systems do exist. One of these issues is directed to the means by which the microwave power is delivered to the reactor. One challenge in power delivery resides in the presence of high intensity electrical fields and the presence of contaminants in chemical reactors.

Usually microwave pyrolysis systems include a microwave waveguide for propagating the microwaves generated by a microwave generator up to the reactor in which pyrolysis will occur. The usual waveguides are rectangular pipes of which the dimensions are set in relation to the microwave wavelength/frequency and microwave reactors generally have internal dimensions that are greater than those of the waveguide. Therefore, the microwave power density is generally greater inside the waveguide (smaller volume) than in the microwave reactor.

At a fixed position inside the reactor and the waveguide, one would experience an electrical and magnetic potential that oscillates in time. If the potential increases above the breakdown voltage of the media, an electrical arc is formed. The electrical arc increases the temperature of the gas and produces a plasma. The plasma is electrically conductive and the oscillating electrical field sustains the electrical arc, which travels in the direction of the highest power density, i.e. in direction of the microwave generator. As it travels towards the microwave generator, the arc damages the metal surfaces and boundaries it touches, i.e. the arc produces sharp edges on metals. The arc can be killed by stopping the microwave injection. Once the microwave injection is resumed, the presence of the sharp edges produced by the previous arc creates points of high electrical field intensity, which increases the risk of going beyond the medium breakdown voltage and promotes the production of another arc. Therefore, the production of arcs leads, in turn, to higher probabilities of arcing. Since the power density inside the waveguide is usually higher compared to the microwave reactor, the risk of arcing inside the waveguide is higher than in the reactor. Therefore, the waveguide environment must be well controlled (cleanliness, high breakdown voltage, no contamination, smooth surfaces, no sharp edges, etc.).

Pyrolysis is usually accompanied with side reactions that produce carbon black particles. These particles are electrically conductive, fine solid particles. When in suspension in a gas, the presence of carbon black particles decreases the gas breakdown voltage and promotes arcing. The presence of other gases and/or liquid produced by the reaction may also decrease the medium breakdown voltage.

Contaminants deposition on the metal surfaces may also lead to hot spots and arcing. For example, in a fixed carbon black particle, an oscillating electrical field will induce an electrical current. Since the electrical resistance of a carbon black particle is not zero, the carbon black particle heats up due to resistive losses. Hot spots may therefore be produced on metal surfaces, which may lead to surface damage, surface melting, sharp edges and/or arcing.

Conventional microwave pyrolysis systems use microwave waveguides having a rectangular cross-sectional shape. In such as a rectangular microwave waveguide, the highest electrical field intensity is located at the middle of the long edge of the waveguide. This corresponds to the TE₁₀ transmission mode, which is the dominant mode for rectangular waveguides. In this case, the deposition of contaminants may lead to hot spots on the metal, metal damage, product of sharp edges and/or arcing.

Furthermore, impedance matching in microwave systems is usually required to maximize the transmitted power from the microwave generator to the reactor and minimize the reflected power. Impedance matching is usually performed using an iris or stub tuners. The iris is a perforated plate and its impedance is a function of the hole size and geometry. Since both size and geometry are fixed, the impedance of an iris is fixed and may not be changed in real-time during microwave injection into the reactor. An iris is therefore a static impedance matching system.

A stub tuner is an impedance matching system configured to be adjustable. A typical stub tuner consists of a waveguide section provided with cylindrical stubs or plungers that are inserted along its long edge and orthogonally into the waveguide wall. Most conventional stub tuners have three spaced apart stubs commonly disposed in a casing attached to the waveguide wall. The insertion depth into the waveguide can be varied to change the characteristic impedance of the tuner. Most stub tuners allow the changing of each individual stub's insertion depth in real-time during microwave injection so as to adjust impedance matching to minimize reflected power. A stub tuner is therefore a dynamic impedance matching system.

Existing stub tuners are designed for matching impedance of systems where impedance mismatch is relatively low (voltage standing wave ratio (VSWR<10:1)). VSWR is used to characterize the impedance mismatch of a microwave system:

$$VSWR = \frac{1 + \vert Γ \vert}{1 - \vert Γ \vert}$$

where Γ is the reflection coefficient.

A typical stub tuner can cover about half of the complete matchable spectrum in a Smith chart. The general goal is to use the stub tuner so that the Smith chart reading is in the middle, being indicative of low reflection of microwaves.

Typically stub tuner can be manually displaced in horizontal and/or vertical positions within the waveguide so as to tune impedance matching. Microwave tuners often use a micrometer carriage drive for vertical displacement. In general stubs are displaced by screw drives.

Automatic stub tuners operate the displacement of the stubs via actuators controlled through a computer interface.

However, when inserted in the microwave field within the waveguide, the stubs are subjected to an electrical and magnetic field, which induces an electrical current on the stub surface. Since the stub material has a non-zero electrical resistance (stubs are usually made of aluminum or copper), resistive heat losses occur on the stubs. Some resistive losses also occur on the waveguide wall, but these are negligible compared to the losses on the stubs.

Due to those resistive losses on the stubs, the stubs heat up and their operating temperature increases. As stub temperatures increase, stubs undergo thermal expansion such that their length and diameter increase. Because of the thermal expansion, the stubs may get squeezed inside the stub casing and screw drives may no longer be moved in and out of the tuner. The system then loses its ability to change the tuner's impedance. Furthermore, forcing the stub to move or out may cause mechanical damage to the stub, stub casing, screw drives and/or actuators.

Also, when higher levels of mismatch are observed the phenomenon worsens and traditional systems start to further heat up and even create recurrent arcing inside the body of the stub tuner assembly. Most existing tuners have either no cooling mechanism to control the stub temperature or they feature a liquid (water, glycol) cooling circuit in the tuner casing. In both cases, the temperature of the stubs, which are the main source of heat are not controlled and this limits the existing tuners' use to low impedance mismatch applications (VSWR<10:1). There is a need for a stub tuner assembly that allows to compensate for high impedance mismatch (such as VSWR≥10) between a microwave generator and a reactor resonant cavity at high power (e.g. 100 kW at 915 MHz and 2450 MHz).

Therefore, there is a need for an improved microwave pyrolysis system and stub tuner assembly that overcomes at least some of the above-identified drawbacks of prior art systems.

### SUMMARY

According to a broad aspect, there is provided an internally cooled microwave stub tuner assembly with stubs having hollow ducts for receiving circulating cooling fluid while in operation. The microwave stub tuner assembly for a pyrolysis reactor is described as comprising at least one elongated hollow body plunger projecting into a waveguide cavity. Each of the hollow body portion of said plungers has at least one internal cooling duct for receiving a circulating cooling fluid and is adapted to be cooled by said circulating cooling fluid as the circulating cooling fluid enters the plunger, courses through each said internal cooling duct and exits the plunger. Each plunge has position adjusting means for adjusting the position of the plunger within the waveguide cavity.

### BRIEF DESCRIPTION OF THE DRAWINGS

Further features and advantages of the present invention will become apparent from the following detailed description, taken in combination with the appended drawings, in which:

FIG. 1 is a cross-section of a microwave pyrolysis system comprising a microwave pyrolysis reactor, a coupler and a stub tuner, in accordance with an embodiment;

FIG. 2 is a cross-sectional view 2 of a stub tuner assembly of FIG. 1 said cross-section being orthogonal to the longitudinal axis of the waveguide;

FIG. 3 is a cross-sectional side view of a stub tuner assembly of FIG. 1 along the outside of the stub tuner assembly;

FIG. 4 is a cross-sectional side view of the stub tuner assembly of FIG. 1 along the longitudinal axis of the stubs;

FIG. 5 is an isolated view of FIG. 4;

FIG. 6 is a perspective cut-away side view of the stub tuner assembly of FIG. 1.

### DETAILED DESCRIPTION

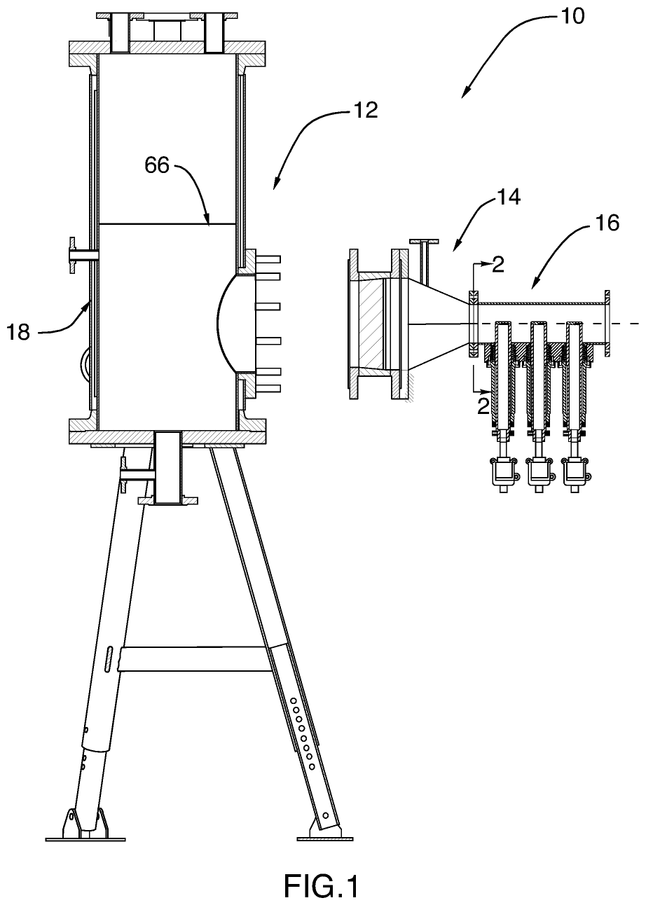

FIG. 1 illustrates one embodiment of a microwave pyrolysis system 10 running on a 915 MHz microwave source for example. System 10 comprises a reactor or vessel 12, a coupler 14 and a stub tuner 16 assembly. It should be understood that the stub tuner assembly 16 is connectable to the source of microwaves or microwave generator (not shown) either directly or via a microwave waveguide. Reactor 12 is configured for performing chemical and/or physical reactions therein under the action of microwave energy.

It should be understood that the shapes, dimensions, inlets and outlets of reactor 12, coupler 14 and stub tuner assembly 16 are merely examples and may vary. For example, while coupler 14 and stub tuner assembly 16 are shown as configured to be connected substantially orthogonally to the longitudinal axis of reactor 12, it should be understood that other embodiments may be possible. The relative proportions of reactor 12, coupler 14 and stub tuner assembly 16 are for illustrative purposes and merely exemplary.

In another embodiment (not shown) there is no coupler 14, in other words no physical interface between the cavity defined within the reactor and the rectangular waveguide of stub tuner assembly 16. However, the absence of a coupler may make the microwave pyrolysis system 10 inadequate for performing chemical reactions that involve multiphase environments (solid, gas and/or liquid) that need to be contained inside reactor 12. Because of the absence of any physical barrier, the solid, gas and/or liquid may interact with the microwaves to produce hot spots, arcing (hot plasma) and failure of stub tuner assembly 16.

Since stub tuner is subjected to a high microwave power density and high electric field, the tendency towards arcing and hot spot production is high. Therefore, installation of an adequate coupler 14 is preferred to minimize arcing and failure of stub tuner assembly 16.

Before use, coupler 14 is assembled to reactor 12 by appropriate means such as nuts and bolts. In an embodiment, coupler 14 has a widened diameter in relation to stub tuner 16 and provides a transfer from a rectangular tubular waveguide shape to a generally cylindrical shape.

Reactor 12 is provided with appropriate inlets and outlets for the material to undergo microwave pyrolysis. An example of material level fill line 66 is shown. In some embodiments reactor 12 is hermetic and adapted to work under vacuum or pressure. Reactor walls 18 can be double-walled or otherwise jacketed to allow for a cooling or heating of the reactor walls 18.

In the illustrated embodiment, stub tuner assembly 16 is used for impedance matching and guiding the microwaves emitted by the microwave generator (not shown) up to coupler 14. Coupler 14 is used for propagating the microwaves coming from stub tuner assembly 16 into reactor 12. Reactor 12 is configured for receiving therein a product to be pyrolyzed which is heated by microwave heating.

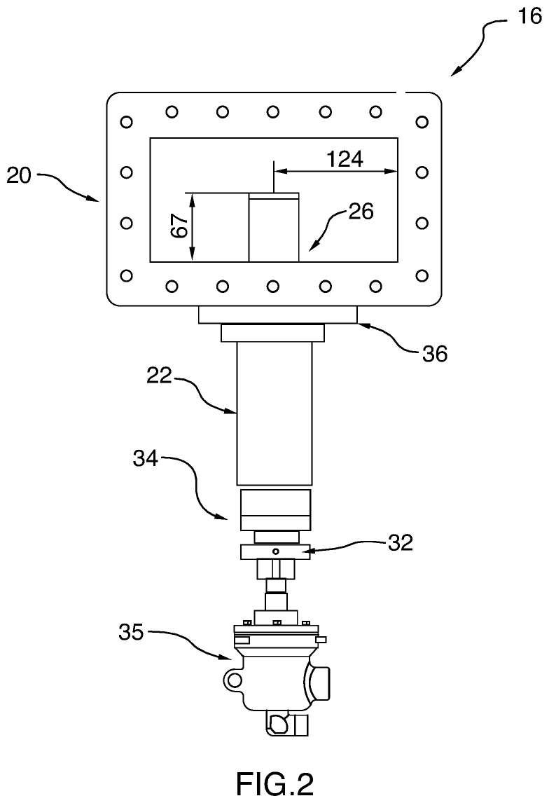

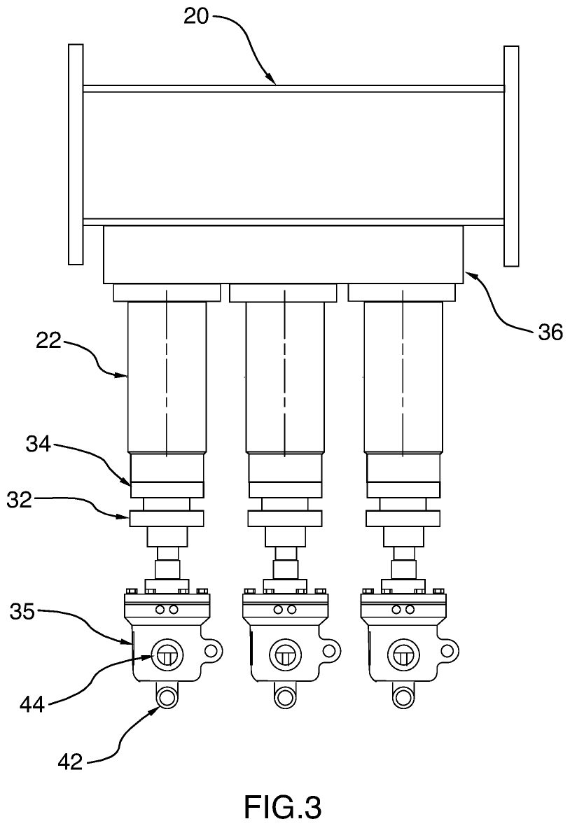

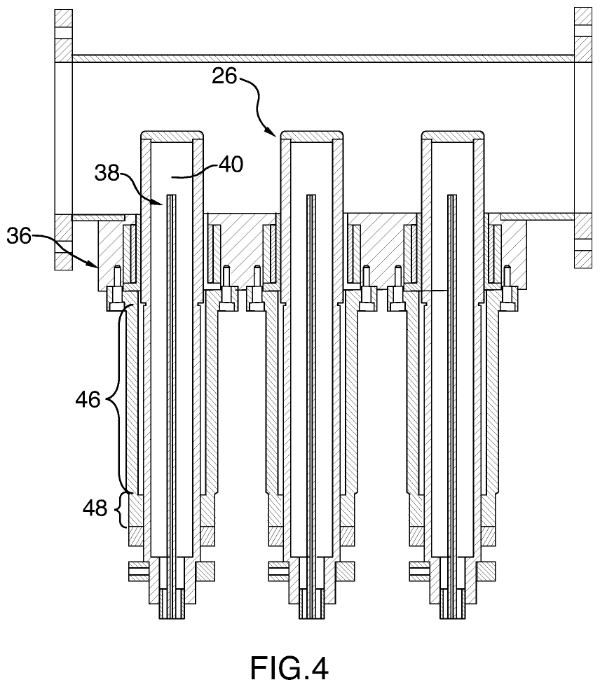

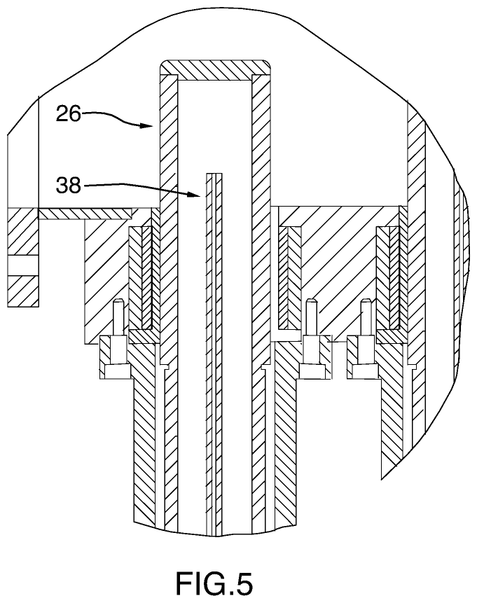

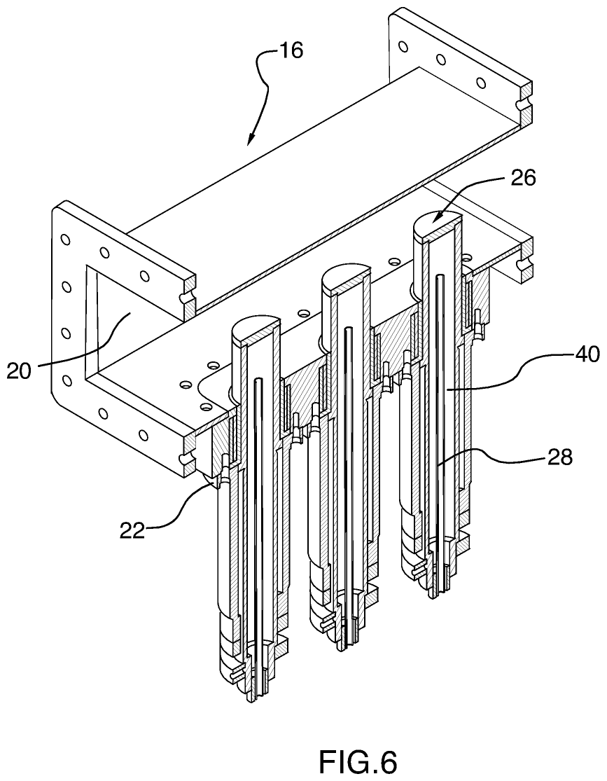

Stub tuner assembly 16 will now be described in further detail by reference to FIGS. 1 to 6.

As illustrated, stub tuner assembly 16 comprises a waveguide cavity 20 enclosed within a microwave waveguide and on which three plunger (stub) housings 22 are attached. A lock nut 24 allows each plunger 26 to be fixed in a certain position within housings 22 and prevents leakage of microwave by ensuring good electrical contact between the plunger threaded section 46 and the housing screw section 48. A secondary lock nut 32 locks the first lock nut 34. While traditional designs would have a plunger threaded section of around ⅛″, the illustrated embodiment proposes a section of roughly >1.0″.

Advantageously, the axial distance between plungers 26 is a function of the wavelength 2, of the microwave field and typically is λ/3.

Typically, the depth that plunger 26 can reach in the waveguide cavity 20 is typically no more than λ/4.

In an embodiment, a cooling fluid is circulated inside each plunger 26 using a dual flow rotary union 35 which allows the cooling fluid to circulate inside plunger 26 while allowing rotation of the plunger 26 for tuning. The rotation of plunger 26 allows displacement of plunger 26 in the axial position going from a totally out position to a position that lands approximately in the middle of the waveguide cavity 20.

Plunger casing 36 allows containment of the microwave and the gap between the plunger 26 and the plunger casing 36 allows for complete or near complete electrical choking of the microwaves. Plunger 26 is a hollow shaft 40 with a cooling tube diameter proportioned at about (λ/6) where λ is the wavelength, to allow circulation of the cooling fluid inside plunger cooling tube 38.

In an embodiment, plunger 26 can be provided by more than one cooling tube so as to achieve more cooling.

Plunger 26 is constructed of a cast or machine material such as metal including steel, copper, aluminum, alloys any thereof or combination materials. In one embodiment, the plunger 26 can be coated with a low electrical loss material, such as silver.

Plunger cooling tube 38 is connected to the cooling fluid inlet 42 and forces cooling fluid to enter the tip of the plunger 26 and leave at the top of the plunger trough the rotary union 35 and fluid outlet 44. One of skill in the art will appreciate that the flow direction of the cooling fluid could also be reversed and that each plunger 26 may advantageously be connected in series to the cooling fluid flow.

In an embodiment the cooling fluid is circulated in an open circuit, for example by use of municipal water. In another embodiment, the cooling fluid is circulated in a closed circuit and connected to a refrigeration exchanger (not shown).

In an embodiment, to prevent arcing between the edge of plunger 26 and plunger casing 36, the minimum plunger length inside the plunger casing 36 is initially set to about one quarter of the internal height of waveguide and adjusted as required for proper impedance matching.

Thus, when impedance mismatch is observed between a load and a source, the stub tuner system of the present invention is used to compensate for the complex portion of the impedance. To this end, plungers 26 are inserted and adjusted in and out of a waveguide cavity 20 to affect the overall system's impedance and ensure that the complex component of the impedance is near 0 (horizontal on a Smith chart) to maximize the power transmitted in the microwave reactor 12.

Thus, when impedance mismatch is observed between a load and a source, the stub tuner assembly, plungers 26 can be displaced and adjusted deeper into the waveguide. In some embodiments additional plungers 26 as described above may also need to be added to further increase the inductance of the system.

It has been observed that dissipative (resistive) energy losses arising from inductive current in the plungers 26 generate heat and that the amount of heat dissipation that is required through is proportional to the depth of the plungers and therefore when high level of mismatch is recorded, larger amount of heat is generated and more cooling is consequently required.

In order to maintain the plungers 26 at constant temperature, the amount, flowrate and nature of the cooling fluid flowing in cooling tube 38 through hollow shaft 40 is chosen.

In one embodiment, the cooling fluid is constantly circulated by a circulating pump (not shown) and monitored by flowrate and/or temperature sensors (not shown) to relay this data to a controller (not shown). The flowrate and/or temperature of the cooling fluid is appropriately controlled and adjusted in real-time by the controller.

In an embodiment, the controller operatively links the source of fluid with a cooling device (not shown) for adjusting the temperature of the fluid to a desired temperature prior to entering cooling tube 38. In a further embodiment, the controller also operatively links the source of fluid to a variable speed circulating pump (not shown). Thus, desired temperature and flow rate of the cooling fluid may be chosen and in a preferred embodiment adjusted in real-time so as to cool the plunger 26 while the stub tuner 16 is in operation.

In one embodiment, each plunger 26 may be provided with a plurality of cooling tubes 38 circulating the cooling fluid. In the same or other embodiments, the length and diameter of cooling tubes 38 may be configured to generate more cooling towards the tip of the plunger 26 which is in the waveguide cavity 20. In some embodiments the cooling tubes 38 may be fluidly connected together so that a single inlet and a single outlet may be present.

In one embodiment, the stub tuner assembly further comprises at least one temperature sensor for sensing the temperature of plungers 26 via measurement of the cooling fluid as in exits plungers 26. In the same or another embodiment, the reactor 12 is provided with at least one flow sensor for sensing the flow of the temperature control fluid. It should be understood that the temperature sensor(s) and/or the flow sensor(s) can be installed at any adequate location to measure the temperature and/or the flow rate of the temperature control fluid, respectively.

In order to allow for moving the plungers in and out, dual fluid rotary unions 35 are installed at the tip of each plungers 26 which allows the plungers to be screwed in and out freely while being cooled down by the circulating cooling fluid.

Also, when high levels of impedance mismatch are observed, plungers 26 are usually moved inward deeper by screwing into the waveguide cavity 20 and out from casing 36.

To further prevent arcing between the end of the plunger and the lower end of the waveguide cavity, the present invention is using a plunger housing 22 with longer straight section than conventional arrangements so as to keep at least a section of at least about five times the distance between housing 22 and plunger 26. This serves to confirm that the microwave electrical field is completely or nearly completely choked and prevents from having electrical fields present in the waveguide cavity 20. Without this extended overlapping section, the plungers may leak out microwave into the waveguide cavity and create unwanted arcing.

The embodiments of the invention described above are intended to be exemplary only. The scope of the invention is therefore intended to be limited solely by the scope of the appended claims.

1. A microwave stub tuner assembly for a pyrolysis reactor, comprising:
at least one elongated hollow body plunger projecting into a waveguide cavity;
each said elongated hollow body plunger having at least one internal cooling duct for receiving a circulating cooling fluid and adapted to be cooled by said circulating cooling fluid as the circulating cooling fluid enters the plunger, courses through each said internal cooling duct and exits the plunger; and
each said elongated hollow body plunger having position adjusting means for adjusting the position of the plunger within the waveguide cavity.

2. A microwave stub tuner assembly as in claim 1 wherein the circulating cooling fluid is in a closed circuit.

3. A microwave stub tuner assembly as in claim 1 wherein the circulating cooling fluid is in an open circuit.

4. A microwave stub tuner assembly as in claim 1 wherein the microwave stub tuner assembly further comprises means for monitoring and controlling the temperature of the circulating cooling fluid.

5. A microwave stub tuner assembly as in claim 1 wherein the microwave stub assembly further comprises means for monitoring and controlling a flow rate of the circulating cooling fluid.

6. A microwave stub tuner assembly as in claim 1 wherein said position adjusting means for adjusting the position of the plunger within the waveguide cavity is automatically adjusted for microwave impedance matching.

7. A microwave stub tuner assembly as in claim 1 wherein the number of elongated hollow body plunger is three or more.

8. A microwave stub tuner assembly as in claim 7 wherein the at least one elongated hollow body plunger is comprises three elongated hollow body plungers.

9. A microwave stub tuner assembly as in claim 1 wherein the diameter of the cooling duct within the elongated hollow body plunger is about (λ/6) where λ is the wavelength.

10. A microwave stub tuner assembly as in claim 7 wherein the axial distance between each plunger is about (λ/3) where λ is the wavelength.

11. A microwave stub tuner assembly as in claim 1 wherein each said elongated hollow body plunger is provided with more than one of the cooling duct.

12. A microwave stub tuner assembly as in claim 1 wherein the cooling ducts are all connected to a single cooling fluid circuit.
